(19) United States
(12) Patent Application Publication
(10) Pub. No.: US 2004/0071969 A1
(43) Pub. Date: Apr. 15, 2004

(54) Bent glass sheet equipped with optical instrument for vehicle

(76) Inventor: Hideki Okamoto, Osaka (JP)

Correspondence Address: MERCHANT & GOULD PC, P.O. BOX 2903, MINNEAPOLIS, MN, 55402-0903, US

(21) Appl. No.: 10/466,837

(22) PCT Filed: May 10, 2002
(86) PCT No.: PCT/JP02/04563

(30) Foreign Application Priority Data
May 11, 2001 (JP) 2001-141291

(51) Int. Cl. B32B 9/00; B32B 17/06

(52) U.S. Cl. 428/410; 428/428; 428/432

(57) ABSTRACT

The present invention provides a bent glass sheet with an optical instrument for a vehicle that irradiates light into the glass sheet. The bent glass sheet includes an antireflective film including at least two layers, and a silica-based film containing silicon oxide as a main component, wherein a main surface of the glass sheet has a first region to be equipped with the optical instrument, wherein the silica-based film is formed on the first region and the antireflective film is formed on a second region of the main surface.

### FIELD OF THE INVENTION

The present invention relates to a bent glass sheet with an optical instrument for a vehicle, and the optical instrument irradiates into the glass sheet. Particularly, the present invention relates to a glass sheet equipped with an optical instrument such as a rain sensor, on which an antireflective layer is formed further.

### BACKGROUND OF THE INVENTION

Functional thin films such as reflective films, antireflective films, colored films, and water-repellent films are formed on surfaces of glass sheets and glass articles by means of various methods such as sputtering, evaporation, and roll coating.

Wet-coating methods including roll coating, dip-coating, and spraying that include a sol-gel process are superior from an aspect of facility cost and productivity to sputtering or evaporation that require a vacuum device, and thus, such wet-coating methods are used in various fields.

Since roll coating enables a continuous production in a large area, it is suitable especially for coating bent glass sheets for vehicles such as automobiles.

The applicants have used sol-gel processes for producing antireflective glass sheets for vehicle windows, and filed applications including JP-A-11-292568, JP-A-2000-177381, JP-A-2000-256040, and JP-A-2000-256042.

Recently, computerization and safety have been emphasized with regard to cars or the like. Communication optical instruments such as ITS are mounted for computerization, while optical instruments such as optical rain sensors are mounted for improving safety.

When a dashboard is reflected on a windshield glass surface, front visibility of the car may deteriorate. For preventing this reflection, an antireflective film can be formed on an inner surface of the windshield glass sheet.

When the above-mentioned optical instrument is used for a windshield glass sheet of antireflective glass, the following inconvenience is expected to occur. That is, functions of the antireflective film coated on the glass surface will degrade performance of the optical instrument.

A basic function of an antireflective film is to prevent reflection by using optical interference in an optical thin film. Such an antireflective film is designed to reduce incident light as much as possible so as to increase transmitted light. In an antireflective film comprising multilayer films as mentioned below, inevitably light enters from a layer having a relatively low refractive index into a layer having a relatively high refractive index. When considering reflection on the backside surface of a transparent substrate, light enters from a low-refractive layer into a high-refractive layer twice or more.

In a method to detect adherence of raindrops by using reflection on the backside surface of a glass sheet, i.e., a method used in an optical rain sensor, reflection loss will be generated at interfaces with different refractive indices due to existence of such antireflective films. This reflection loss will degrade output of a photoreceptor.

An antireflective film is provided for decreasing light reflected to the incident side in consideration of the backside reflection of a transparent substrate. Therefore, when an optical instrument for using backside reflection of a transparent substrate is combined with a transparent substrate provided with an antireflective film, reflected light is decreased, and thus, performance of the optical instrument will deteriorate.

For an antireflective film used for windshield glass, reflection caused by light entering obliquely should be suppressed for preventing reflection of a dashboard. As a result, performance of an optical instrument using backside reflection deteriorates particularly.

In order to make performance of an optical instrument compatible with performance of an antireflective film, such an antireflective film can be removed at a part to be equipped with the optical instrument, or formation of such an antireflective film is not carried out at such a part.

In many cases, window glass sheets for vehicles are bent for use. When the glass sheet surface is not provided with an antireflective film at a part, bending degree of the glass sheet varies under the influence of film stress when the glass sheet is heated for bending, which will lead to optical strains.

### DISCLOSURE OF THE INVENTION

The present invention provides a bent glass sheet with an optical instrument for a vehicle, the optical instrument irradiating light into the glass sheet, comprising: an antireflective film including at least two layers, and a silica-based film containing silicon oxide as a main component, wherein a main surface of the glass sheet has a first region to be equipped with the optical instrument, and the silica-based film is formed on said first region and the antireflective film is formed on a second region of the main surface.

In this specification, a silica-based film denotes a film that includes 50 wt % or more of silicon oxide (a film that includes silicon oxide as a main component).

### BRIEF DESCRIPTION OF THE DRAWINGS

FIG. 1 is a partial cross-sectional view showing a structure of a bent glass sheet with an optical instrument for a vehicle, according to the present invention.

FIG. 2 is a partial cross-sectional view showing a structure of a bent glass sheet for a vehicle, which is described in Example 2.

FIG. 3 is a partial cross-sectional view showing a structure of a bent glass sheet for a vehicle, which is described in Comparative Example 1.

FIG. 4 is a schematic view showing a perspective strain in a bent glass sheet for a vehicle, which is described in Comparative Example 1.

### DETAILED DESCRIPTION OF THE INVENTION

In the bent glass sheet of the present invention, the antireflective film preferably comprises a first layer having a refractive index higher than a refractive index of the glass sheet and a second layer formed on the first layer and having a refractive index lower than the refractive index of the glass sheet. The second layer may be a silica-based film.

The first layer preferably has a refractive index (n₁) ranging from 1.65 to 2.20 and a film thickness ranging from 110 nm to 150 nm and the second layer preferably has a refractive index (n₂) ranging from 1.37 to 1.49 and a film thickness ranging from 81 nm to 100 nm.

In this specification, refractive indexes are based on the values at a wavelength of 550 nm.

The refractive index (n₁) of the first layer may range from 1.67 to 1.8 and the refractive index (n₂) of the second layer may range from 1.40 to 1.47. It is preferable that the silica-based film and the second layer are integrated.

The first layer and the second layer can be formed by a sol-gel process. Examples of the optical instrument include an optical rain sensor.

In the present invention, the antireflective film should not be formed on a region to be equipped with an optical instrument, while a silica-based film is preferably formed directly on the region.

Accordingly, the glass sheet has less optical strains under an influence of film stress caused by heat during a bending step, even when an antireflective film is not formed on the region.

In general, antireflective films formed on transparent substrates are classified into several groups depending on the numbers of the layers: a monolayer structure, a two-layer structure, a three-layer structure and a multilayer structure.

An antireflective film of a monolayer structure is formed on a transparent substrate of a glass sheet, and the film has a refractive index lower than that of the glass sheet. Examples of applicable materials with low refractive indices include MgF₂ and SiO₂.

Since such a monolayer structure cannot provide a sufficient antireflection effect, an antireflective film that is used in general has a two-layer structure as a combination of a layer having a refractive index higher than that of the glass sheet and a layer having a refractive index lower than that of the glass sheet.

When a two-layer structure cannot provide a sufficient antireflection effect, the antireflective film can be composed of a three-layer structure of a low-refractive layer, an intermediate-refractive layer and a high-refractive layer. The antireflective film can be composed of four or more layers.

In any of the antireflective films, the top layer should have a refractive index lower than that of the transparent substrate. For example, the above-mentioned MgF₂ and SiO₂ can be used for materials having refractive indices lower than that of a glass sheet. However, since MgF₂ does not have a sufficient durability or weather-resistance and difficult to endure heat applied during a step of bending the glass sheet, SiO₂ is a preferable material that can be used for such an application.

In a case of application of an antireflective film to a bent glass sheet for a vehicle, it is preferable to form an antireflective film in a flat state and subsequently applying heat for bending the glass sheet, when considering uniformity of film thickness or the like.

The following equation 1 is for calculating a refractive index of a high-refractive material to be combined with SiO₂ (n₂=1.46) as a low-refractive material in a antireflective film of a two-layer structure that can provide an improved antireflection effect in a relatively simple structure. A relationship between n₁ and n₂ can be represented as follows where n_{g} denotes a refractive index of glass (1.52) and no denotes a refractive index of air (1.0).

n₁=[(n₂)²×n_{g}/nₒ]^{1/2} (Equation 1)

Based on this equation, n₁ is preferably 1.80.

A sol-gel process is preferred for film formation from an aspect of application to a glass sheet for a vehicle, since a film formed by the sol-gel process can be used for a large area and the method does not require complicated facilities.

There is no proper material having a refractive index (n₁) of about 1.80 among individual materials applicable for film formation by a sol-gel process. Alternatively, a layer for the purpose can be prepared by mixing TiO₂ (n=2.2) and SiO₂ (n=1.46). Both TiO₂ and SiO₂ can be used for film formation by a sol-gel process. ZrO₂ (n=1.95), CeO₂, Bi₂O₃ or the like can be added further to form a high-refractive layer.

A SiO₂ layer as a low-refractive material layer also can be formed by a sol-gel process. Furthermore, the film can be made porous to lower its apparent refractive index. Or the refractive index can be lowered by mixing inorganic microparticles having a low-refractive index. Antireflection effect can be improved by lowering the refractive index of the second layer. The silica-based second layer can contain B₂O₃ and/or Al₂O₃.

In the antireflective film of a two-layer structure, it is preferable that the first layer has a refractive index (n₁) ranging from 1.65 to 2.20 and a thickness ranging from 110 nm to 150 nm, while the second layer has a refractive index (n₂) ranging from 1.37 to 1.49 and a thickness ranging from 81 nm to 100 nm.

It is further preferable that the first layer has a refractive index (n₁) ranging from 1.67 to 1.8 and the second layer has a refractive index (n₂) ranging from 1.40 to 1.47.

An antireflective film having the above-mentioned two-layer structure provides an improved antireflection effect with respect to oblique light, which is an important factor for application to a glass sheet for a vehicle, especially for a windshield glass sheet.

Moreover, a silica-based film, which is formed on a region to be equipped with an optical instrument, can be formed by a sol-gel process.

### EXAMPLES

(Preparation of Coating Solution)

Steps for preparing a coating solution for forming an antireflective film are described as follows.

A solution A was prepared by hydrolyzing 500 g of “Ethyl Silicate 40” (COLCOAT CO., Ltd) by using 410 g of ethylcellosolve and 90 g of 0.1 mol/L hydrochloric acid, and stirring the product further.

Next, a solution B was prepared by mixing 65.5 g of titanium tetraisopropoxide and 64.1 g of acetyl acetone.

The solution A and solution B were mixed at a rate of 1:1, and diluted properly in an ethylcellosolve solvent to prepare a coating solution C.

Moreover, the solution A was diluted properly with an ethylcellosolve solvent in order to prepare a coating solution D.

### Example 1

First, a soda-lime-silica glass sheet was manufactured by a float process, and the glass sheet was cut to be a predetermined size and washed. The coating solution C was coated on the glass sheet by roll coating. At this time, a flexographic plate was notched partly so that the solution would not be coated on a region to be equipped with an optical instrument.

The coated glass sheet was dried at about 300° C. Subsequently, the coating solution D was coated similarly by roll coating on the whole surface of this glass sheet, and the glass sheet was dried again at 300° C. Thereby, the coating solution D was coated on the main surface of the glass sheet as a whole, including the region to be equipped with an optical instrument.

This glass sheet was fired at temperatures from 620° C. to 630° C., and bent to be a glass sheet for an automobile. The bending step was carried out with the self-weight in a furnace (sag bending), by laminating the glass sheet and a similarly-shaped non-coated glass sheet and by mounting the laminated glass sheets on a mould.

A glass sheet obtained in this manner is provided with an antireflective film of a two-layer structure. The first layer has a refractive index (n) of about 1.74, a film thickness (d) of about 130 nm, while the second layer has a refractive index (n) of about 1.44 and a film thickness (d) of about 90 nm.

Through an ordinary lamination step, a laminated safety glass sheet for windshield, i.e., a bent glass sheet with an antireflective film for an automobile, was obtained by sandwiching an interlayer of a PVB film between the glass sheet having the antireflective film facing inside of the car and the separate non-coated glass sheet facing outside.

In this example, a silica-based film, which is formed directly on a region to be equipped with an optical instrument, is integrated so that the film functions also as a top layer of an antireflective film of a two-layer structure. Production steps can be simplified in this manner.

The surface provided with an antireflective film faces inside of the car, while the other glass sheet facing outside of the car is not provided with such a film.

When at least a silica-based film is formed directly on a region of a surface of a glass sheet equipped with an optical instrument, optical strains can be reduced to a negligible level even if the antireflective film is formed on the main surface of the glass sheet, since an influence of the film stress is reduced during a step of bending the glass sheet.

For the above-mentioned bent glass sheet with an antireflective film for automobile, a module of a rain sensor as an optical instrument was attached to the region where the first layer was not formed.

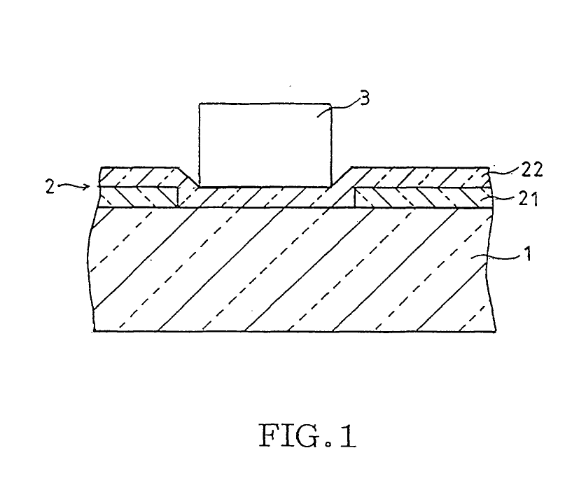

FIG. 1 shows a cross section of the region equipped with the optical instrument. In FIG. 1, the optical instrument 3 is arranged in a region where only a low-refractive index film (second layer; SiO₂) 22 is formed. A antireflective film 2 composed of the low-refractive index film 22 and a high-refractive film (first layer; TiO₂+SiO₂) 21 are formed on the other region on the glass sheet 1.

The thus obtained bent glass sheet with an antireflective film for an automobile met the standards for safety glass for automobiles. It showed excellent optical properties, as no image strains were found on the region to be equipped with an optical instrument. The main surface of the glass sheet has an antireflection function, so that it provides good visibility for a driver, preventing reflection of the dashboard.

For the bent glass sheet with an antireflective film for an automobile, optical spectra were measured in the region to be equipped with an optical instrument in order to check influences of output to the sensor. The optical instrument in this case was a rain sensor using a light beam having a wavelength of 700 nm.

With regard to the glass sheet in Example 1, transmissivity was about 99.8% in a calculation performed by considering only a loss at the interface at a time that light entered at an angle of 45°.

In Example 1, the glass sheet with a rain sensor is designed such that light is reflected twice on the external glass sheet as a sensor surface and thus, there are four interfaces within the range from the low-refractive layer to the high-refractive layer. That is, the change in output of the sensor is reduced by the fourth power of the transmissivity. The decrease of the reflected light in Example 1 was about 0.8%, which is small sufficiently to be negligible.

### Example 2

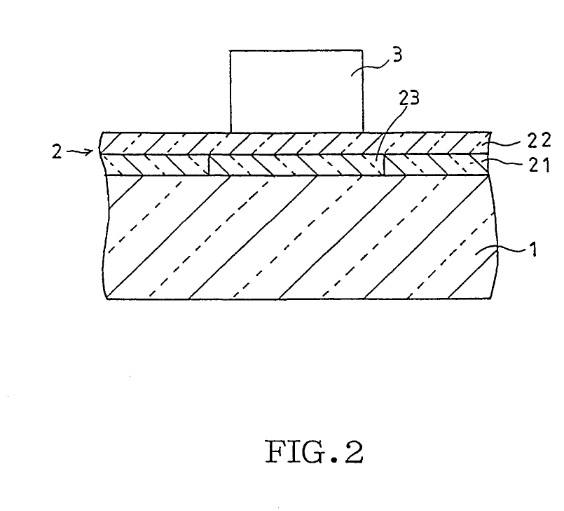

In Example 2, as shown in FIG. 2, the solution D was coated before forming a low-refractive layer on a region having no coating of the solution C in Example 1, and further coating the solution D on the whole surface of the glass sheet to form a low-refractive index film (SiO₂) 23.

Such a structure where the additional low-refractive index film 23 has substantially the same thickness as the first layer 21 of the antireflective film is helpful in preventing substantially influences of the film stress generated at the time of bending of the glass sheet. This embodiment is preferable since substantially no optical strains will occur.

### Comparative Example 1

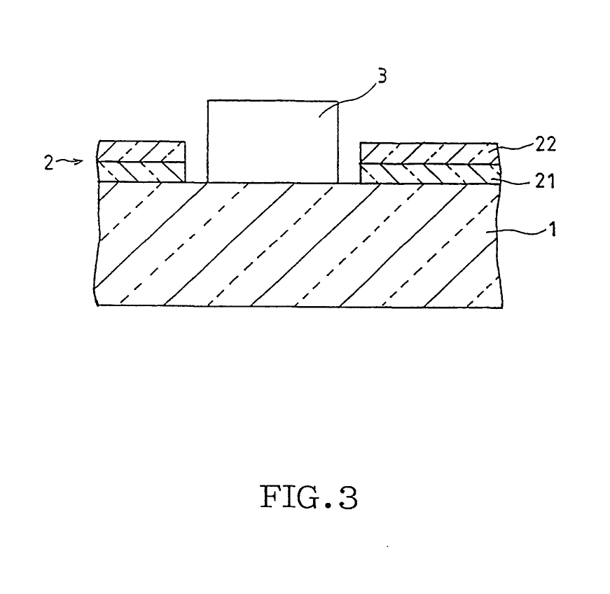

A bent glass sheet with an antireflective film for an automobile was manufactured by using the coating solutions described in Example 1. In Comparative Example 1, either the first layer or the second layer of the coating solution D was not coated on the region to be equipped with an optical instrument. In other words, no reflective films were formed on the region to be equipped with an optical instrument (see FIG. 3).

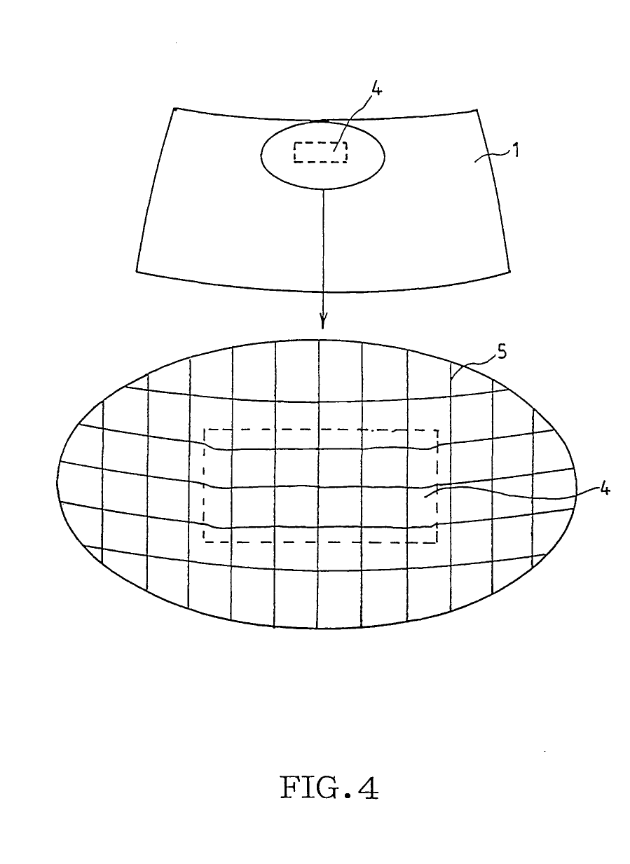

A lattice pattern was observed through the thus obtained bent glass sheet with an antireflective film for an automobile. FIG. 4 is a schematic view showing the observation result. As shown in FIG. 4, an optical strain occurred during a bending process at the boundary between the region having the antireflective film and the region without the antireflective film 4. As a result, the glass sheet obtained in Comparative Example 1 provided strained perspective images (see a lattice pattern 5 in FIG. 4), i.e., the glass sheet does not meet the standards for automobile glass.

### Comparative Example 2

A bent glass sheet with an antireflective film for an automobile was manufactured by using the coating solutions described in Example 1, though a two-layered antireflective film was formed on the main surface including the region to be equipped with an optical instrument.

With regard to the thus obtained bent glass sheet with an antireflective film, the transmissivity was about 97% in a calculation in consideration of only a loss at an interface as in Example 1, in the region to be equipped with an optical instrument. In other words, reduction of the reflected light in Comparative Example 2 was about 11.5%, i.e., a considerable signal loss was generated.

The above explanation is based on examples in which coating solutions prepared by a sol-gel process are coated by roll coating. In the present invention, the coating method is not limited to the roll coating, but any other methods such as dip coating, sputtering, and evaporation can be used for forming a functional thin film.

In the above explanation of the Example, the antireflective films have two-layer structures. The structure is not limitative, but the present invention can be applied similarly to antireflective films comprising three or more layers. However, since process steps should be increased as the films have more layers, an antireflective film of a two-layer structure is preferred from an aspect of balanced antireflection performance and production cost performance.

For an antireflective film composed of three or more layers, a top layer as a low-refractive layer can be formed alone on the main surface of the glass sheet as a whole, without forming layers other than the top layer in a region to be equipped with an optical instrument.

As mentioned above, for a bent glass sheet with an optical instrument for a vehicle according to the present invention, influences of film stress during a bending process can be relieved by forming a silica-based film directly on a region of a glass sheet surface to be equipped with an optical instrument.

Accordingly, the antireflective performance of the main surface of the bent glass sheet for a vehicle can be maintained while deterioration in the performance of the optical instrument irradiating light can be prevented.

Furthermore, the manufacturing steps can be simplified by integrating the silica-based film in the region to be equipped with an optical instrument together with a second layer of an antireflective film having a two-layer structure.

1. A bent glass sheet with an optical instrument for a vehicle, the optical instrument irradiating light into the glass sheet, comprising:
an antireflective film including at least two layers, and a silica-based film containing silicon oxide as a main component,
wherein a main surface of the glass sheet has a first region to be equipped with the optical instrument,
wherein the silica-based film is formed on said first region and the antireflective film is formed on a second region of the main surface.

2. The bent glass sheet according to claim 1, wherein the antireflective film comprises a first layer having a refractive index higher than a refractive index of the glass sheet and a second layer formed on the first layer and having a refractive index lower than the refractive index of the glass sheet.

3. The bent glass sheet according to claim 2, wherein the second layer is a silica-based film.

4. The bent glass sheet according to claim 2, wherein the first layer has a refractive index (n₁) ranging from 1.65 to 2.20 and a film thickness ranging from 110 nm to 150 nm and the second layer has a refractive index (n₂) ranging from 1.37 to 1.49 and a film thickness ranging from 81 nm to 100 nm.

5. The bent glass sheet according to claim 4, wherein the refractive index (n₁) of the first layer ranges from 1.67 to 1.8 and the refractive index (n₂) of the second layer ranges from 1.40 to 1.47.

6. The bent glass sheet according to claim 2, wherein the silica-based film and the second layer are integrated.

7. The bent glass sheet according to claim 4, wherein the first layer and the second layer are formed by a sol-gel process.

8. The bent glass sheet according to claim 1, wherein the optical instrument is an optical rain sensor.
